(19) United States
(12) Patent Application Publication
(10) Pub. No.: US 2017/0274617 A1
(43) Pub. Date: Sep. 28, 2017

(54) BINDING PROCESS DEVICE AND RECORDING-MEDIUM PROCESSING SYSTEM

(71) Applicant: FUJI XEROX CO., LTD., Tokyo (JP)

(72) Inventors: Takuya MAKITA, Kanagawa (JP); Hiroaki AWANO, Kanagawa (JP); Yoshinori NAKANO, Kanagawa (JP); Katsumi HARADA, Kanagawa (JP); Kojiro TSUTSUMI, Kanagawa (JP); Yasuhiro KUSUMOTO, Kanagawa (JP); Hiroshi HAGIWARA, Kanagawa (JP); Emiko SHIRAISHI, Kanagawa (JP); Junichi HIROTA, Kanagawa (JP)

(73) Assignee: FUJI XEROX CO., LTD., Tokyo (JP)

(21) Appl. No.: 15/246,627

(22) Filed: Aug. 25, 2016

(30) Foreign Application Priority Data
Mar. 24, 2016 (JP) 2016-060770

(51) Int. Cl. B31F 5/02; B65H 37/04; B42B 5/00

(52) U.S. Cl. CPC B31F 5/02; B42B 5/00; B65H 37/04; B65H 2801/27

(57) ABSTRACT

A binding process device includes an advancing member and an advancing unit. The advancing member has a first end and a second end located opposite from the first end and advances toward a surface of a recording-medium bundle so as to press against the recording-medium bundle. The advancing unit causes the advancing member to advance toward the surface of the recording-medium bundle. When the advancing member advances toward the surface of the recording-medium bundle so as to press against the recording-medium bundle, at least one of the first end and the second end of the advancing member is positioned outside an edge of the recording-medium bundle.

### CROSS-REFERENCE TO RELATED APPLICATIONS

This application is based on and claims priority under 35 USC 119 from Japanese Patent Application No. 2016-060770 filed Mar. 24, 2016.

### BACKGROUND

### Technical Field

The present invention relates to binding process devices and recording-medium processing systems.

### SUMMARY

According to an aspect of the invention, there is provided a binding process device including an advancing member and an advancing unit. The advancing member has a first end and a second end located opposite from the first end and advances toward a surface of a recording-medium bundle so as to press against the recording-medium bundle. The advancing unit causes the advancing member to advance toward the surface of the recording-medium bundle. When the advancing member advances toward the surface of the recording-medium bundle so as to press against the recording-medium bundle, at least one of the first end and the second end of the advancing member is positioned outside an edge of the recording-medium bundle.

### BRIEF DESCRIPTION OF THE DRAWINGS

Exemplary embodiments of the present invention will be described in detail based on the following figures, wherein:

FIG. 1 illustrates the configuration of a recording-medium processing system;

FIG. 2 illustrates the configuration of a post-processing apparatus;

FIG. 3 illustrates a binding process device, as viewed from above;

FIGS. 4A and 4B are cross-sectional views taken along line IV-IV in FIG. 3;

FIG. 5 illustrates a second advancing member, as viewed in the direction of an arrow V in FIG. 4A;

FIG. 6 illustrates a binding process performed on a corner of a sheet bundle;

FIG. 7 illustrates a comparative example of a binding process performed on a sheet bundle;

FIG. 8 illustrates another processing example for a sheet bundle;

FIG. 9 illustrates another example of a binding process performed on a sheet bundle; and

FIG. 10 illustrates another example of a binding process performed on a sheet bundle.

### DETAILED DESCRIPTION

An exemplary embodiment of the present invention will be described below with reference to the appended drawings.

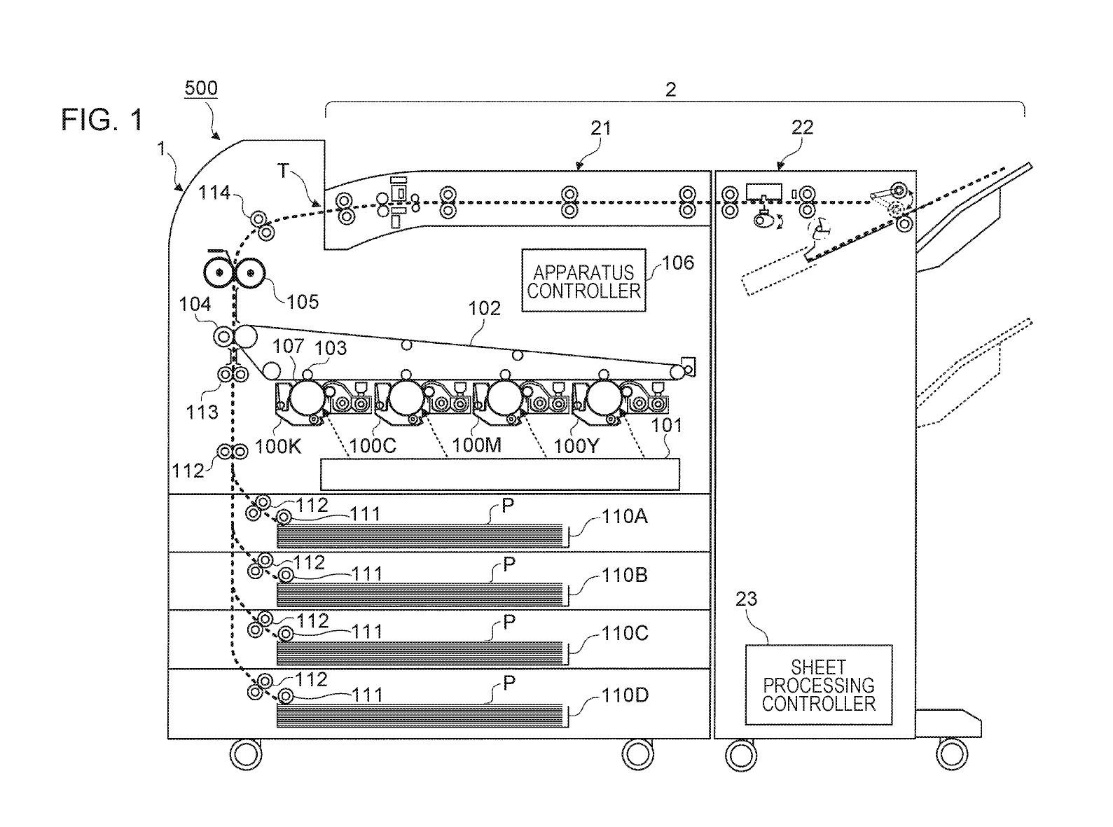

FIG. 1 illustrates the configuration of a recording-medium processing system 500 according to this exemplary embodiment.

The recording-medium processing system 500 according to this exemplary embodiment is provided with an image forming apparatus 1 that forms an image onto a recording medium, such as a sheet P, by, for example, electrophotography and a post-processing apparatus 2 that performs post-processing on multiple sheets P having images formed thereon by the image forming apparatus 1.

The image forming apparatus 1 is of a so-called tandem type and includes four image forming units 100Y, 100M, 100C, and 100K (which may also be collectively referred to as “image forming units 100”) that form images based on image data of respective colors. The image forming apparatus 1 is provided with a laser exposure device 101 that radiates exposure light onto photoconductor drums 107 provided in the individual image forming units 100 so as to form electrostatic latent images on the surfaces of the photoconductor drums 107.

Furthermore, the image forming apparatus 1 is provided with an intermediate transfer belt 102 onto which toner images of the respective colors formed at the image forming units 100 are superposed and transferred, and is also provided with first-transfer rollers 103 that sequentially transfer (first-transfer) the toner images formed at the image forming units 100 onto the intermediate transfer belt 102. Moreover, the image forming apparatus 1 is provided with a second-transfer roller 104 that collectively transfers (second-transfers) the toner images transferred on the intermediate transfer belt 102 onto a sheet P, a fixing device 105 that fixes the second-transferred toner images onto the sheet P, and an apparatus controller 106 that controls the operation of the image forming apparatus 1.

In each image forming unit 100, the photoconductor drum 107 is electrostatically charged, and an electrostatic latent image is formed on the photoconductor drum 107. The electrostatic latent image is developed so that a toner image of the corresponding color is formed on the surface of the photoconductor drum 107.

The toner images formed on the surfaces of the individual photoconductor drums 107 are sequentially transferred onto the intermediate transfer belt 102 by the first-transfer rollers 103. Then, as the intermediate transfer belt 102 moves, the toner images are transported to a position where the second-transfer roller 104 is disposed.

The image forming apparatus 1 has sheet accommodation sections 110A to 110D that accommodate therein sheets P of different sizes and different types. For example, a sheet P is picked up from the sheet accommodation section 110A by a pickup roller 111, and this sheet P is transported to a registration roller 113 by a transport roller 112.

Then, in accordance with a timing at which the toner images on the intermediate transfer belt 102 are transported to the second-transfer roller 104, the sheet P is fed from the registration roller 113 toward an opposing section (i.e., a second-transfer section) where the second-transfer roller 104 and the intermediate transfer belt 102 face each other.

The toner images on the intermediate transfer belt 102 are then collectively electrostatically transferred (second-transferred) onto the sheet P due to the effect of a transfer electric field generated by the second-transfer roller 104.

Subsequently, the sheet P having the toner images transferred thereon is separated from the intermediate transfer belt 102 and is transported toward the fixing device 105. The fixing device 105 performs a fixing process by using heat and pressure so as to fix the toner images onto the sheet P, whereby an image is formed on the sheet P.

Then, the sheet P having the image formed thereon is output from a sheet output section T of the image forming apparatus 1 by a transport roller 114 and is fed to the post-processing apparatus 2 connected to the image forming apparatus 1.

The post-processing apparatus 2 is disposed downstream of the sheet output section T of the image forming apparatus 1 and performs post-processing, such as a hole-punching process and a binding process, on the sheet P having the image formed thereon.

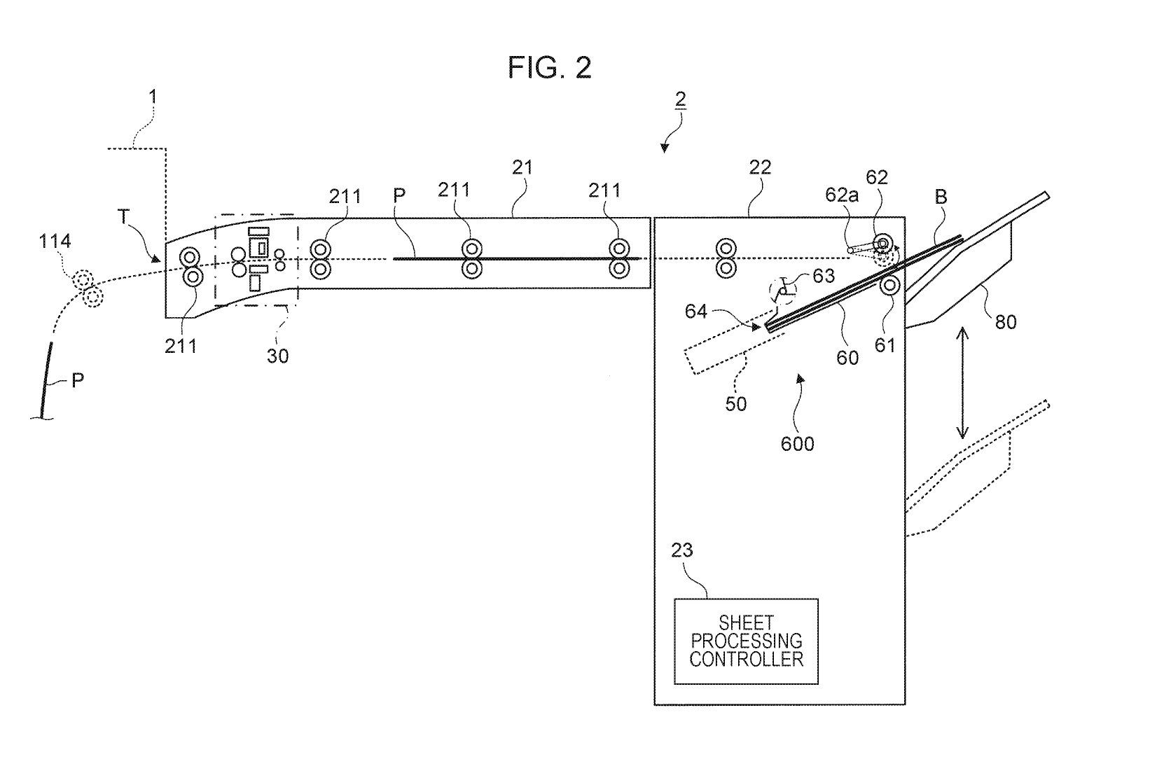

FIG. 2 illustrates the configuration of the post-processing apparatus 2.

As shown in FIG. 2, the post-processing apparatus 2 includes a transport unit 21 connected to the sheet output section T of the image forming apparatus 1 and also includes a finisher unit 22 that performs a predetermined process on the sheet P transported by the transport unit 21.

The post-processing apparatus 2 also includes a sheet processing controller 23 that controls each functional unit of the post-processing apparatus 2. The sheet processing controller 23 is connected to the apparatus controller 106 (see FIG. 1) by a signal line (not shown) and exchanges, for example, control signals therewith.

Furthermore, the post-processing apparatus 2 includes a stacker section 80 on which sheets P (i.e., a sheet bundle B) that have undergone a process performed by the post-processing apparatus 2 are stacked.

Although the sheet processing controller 23 is provided within a housing of the finisher unit 22 in the post-processing apparatus 2 according to this exemplary embodiment, the sheet processing controller 23 may alternatively be provided within a housing of the image forming apparatus 1 (see FIG. 1). Furthermore, the apparatus controller 106 of the image forming apparatus 1 may alternatively have the control function of the sheet processing controller 23.

As shown in FIG. 2, the transport unit 21 of the post-processing apparatus 2 is provided with a punching functional unit 30 that performs, for example, a two-hole or four-hole punching process.

Moreover, the transport unit 21 is provided with multiple transport rollers 211 that transport the sheet P having the image formed thereon in the image forming apparatus 1 toward the finisher unit 22.

The finisher unit 22 is provided with a binding process device 600 that performs a binding process on a sheet bundle B as an example of a recording-medium bundle. Specifically, the binding process device 600 according to this exemplary embodiment binds a sheet bundle B together without using staples.

The binding process device 600 is provided with a sheet accumulation section 60 that supports sheets P from below and accumulates a predetermined number of sheets P so as to form a sheet bundle B. The binding process device 600 is also provided with a binding unit 50 that binds the sheet bundle B together.

In this exemplary embodiment, the binding process performed on the sheet bundle B involves pressing advancing members (to be described later) provided in the binding unit 50 against the sheet bundle B from opposite faces of the sheet bundle B so as to bring the sheets P constituting the sheet bundle B into pressure contact with each other (i.e., to cause the fibers constituting the sheets P to entwine).

Furthermore, the binding process device 600 is provided with a transport roller 61 and a movable roller 62. The transport roller 61 rotates clockwise in FIG. 2 and delivers the sheet bundle B on the sheet accumulation section 60 toward the stacker section 80.

The movable roller 62 is provided in a movable manner about a rotation shaft 62a and is located at a receded position from the transport roller 61 when sheets P are to be accumulated on the sheet accumulation section 60. When delivering the created sheet bundle B toward the stacker section 80, the movable roller 62 is pressed against the sheet bundle B on the sheet accumulation section 60.

A process performed in the post-processing apparatus 2 will now be described.

In this exemplary embodiment, a command signal indicating that a process is to be executed on a sheet P is output from the apparatus controller 106 to the sheet processing controller 23. The sheet processing controller 23 receives this command signal so that the post-processing apparatus 2 executes the process on the sheet P.

In the process performed in the post-processing apparatus 2 (see FIG. 2), the sheet P having the image formed thereon in the image forming apparatus 1 is first fed to the transport unit 21 of the post-processing apparatus 2. In the transport unit 21, the punching functional unit 30 performs a hole-punching process in accordance with the command signal from the sheet processing controller 23, and the transport rollers 211 subsequently transport the sheet P toward the finisher unit 22.

If there is no hole-punching command from the sheet processing controller 23, the sheet P is delivered to the finisher unit 22 without undergoing the hole-punching process by the punching functional unit 30.

The sheet P delivered to the finisher unit 22 is transported to the sheet accumulation section 60 provided in the binding process device 600. Then, the sheet P slides on the sheet accumulation section 60 in accordance with an inclination angle given to the sheet accumulation section 60 so as to abut on sheet regulation sections 64 provided at an end of the sheet accumulation section 60.

Thus, the sheet P stops moving. In this exemplary embodiment, the sheet P abuts on the sheet regulation sections 64 so that a sheet bundle B having sheets P with aligned trailing edges is created on the sheet accumulation section 60. In this exemplary embodiment, a rotating paddle 63 that moves the sheet P toward the sheet regulation sections 64 is further provided.

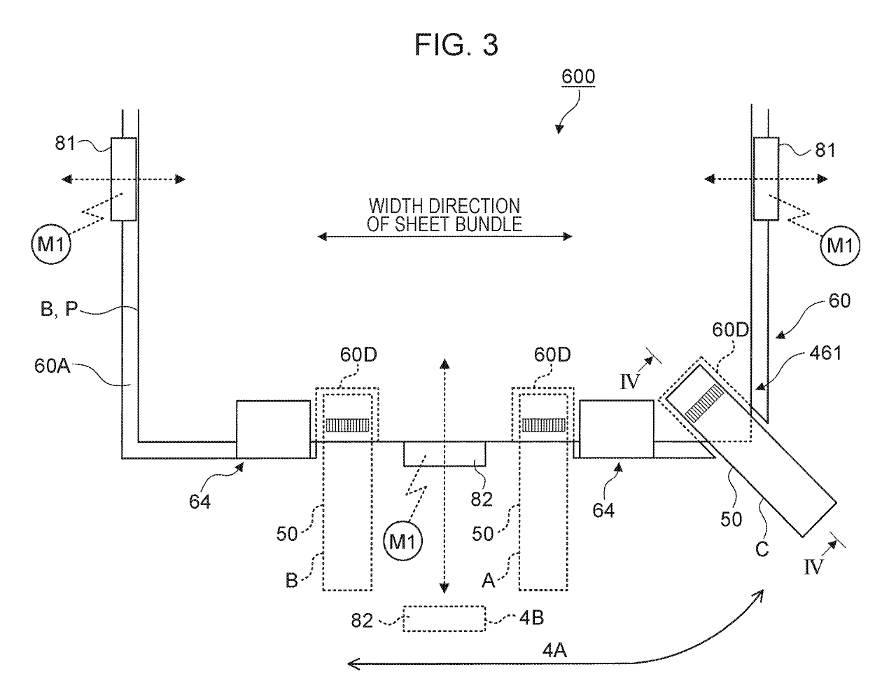

FIG. 3 illustrates the binding process device 600, as viewed from above.

The opposite widthwise edges of the sheet accumulation section 60 are provided with first movable members 81.

The first movable members 81 are pressed against the edges of sheets P constituting the sheet bundle B so as to positionally align the edges of the sheets P constituting the sheet bundle B. Moreover, the first movable members 81 move in the width direction of the sheet bundle B so as to move the sheet bundle B in the width direction of the sheet bundle B.

In detail, in this exemplary embodiment, when sheets P are to be accumulated on the sheet accumulation section 60, the first movable members 81 are pressed against the edges of the sheets P so as to positionally align the edges of the sheets P.

If the binding process is to be performed at two binding positions, namely, a first binding position 8A and a second binding position 8B, which will be described later, the first movable members 81 press against the sheet bundle B so as to move the sheet bundle B in the width direction of the sheet bundle B.

Furthermore, the binding process device 600 according to this exemplary embodiment is provided with a second movable member 82.

The second movable member 82 moves in the vertical direction in FIG. 3 so as to move the sheet bundle B in a direction orthogonal to the width direction of the sheet bundle B.

Moreover, movement motors M1 for moving the first movable members 81 and the second movable member 82 are provided in this exemplary embodiment.

As indicated by an arrow 4A in FIG. 3, the binding unit 50 is movable in the width direction of the sheet bundle B. For example, the binding unit 50 performs a binding process (i.e., a two-point binding process) at two points (position A and position B) located at different positions in the width direction of the sheet bundle B.

Moreover, the binding unit 50 moves to position C in FIG. 3 so as to perform a binding process (i.e., a one-point binding process) on a corner of the sheet bundle B.

The binding unit 50 moves linearly between position A and position B, whereas the binding unit 50 moves while rotating by, for example, 45° between position A and position C.

In this exemplary embodiment, the binding unit 50 performs the binding process in areas where the sheet regulation sections 64 and the second movable member 82 are not provided.

In detail, as shown in FIG. 3, the binding unit 50 performs the binding process between the left sheet regulation section 64 and the second movable member 82 as well as between the right sheet regulation section 64 and the second movable member 82. Moreover, in this exemplary embodiment, the binding unit 50 performs the binding process in an area adjacent to the right sheet regulation section 64 (i.e., a corner of the sheet bundle B).

As shown in FIG. 3, a base plate 60A is provided with three cutouts 60D. Thus, interference between the sheet accumulation section 60 and the binding unit 50 may be avoided.

Furthermore, in this exemplary embodiment, when the binding unit 50 is to move, the second movable member 82 moves to a position indicated by a reference sign 4B in FIG. 3. Thus, interference between the binding unit 50 and the second movable member 82 may be avoided.

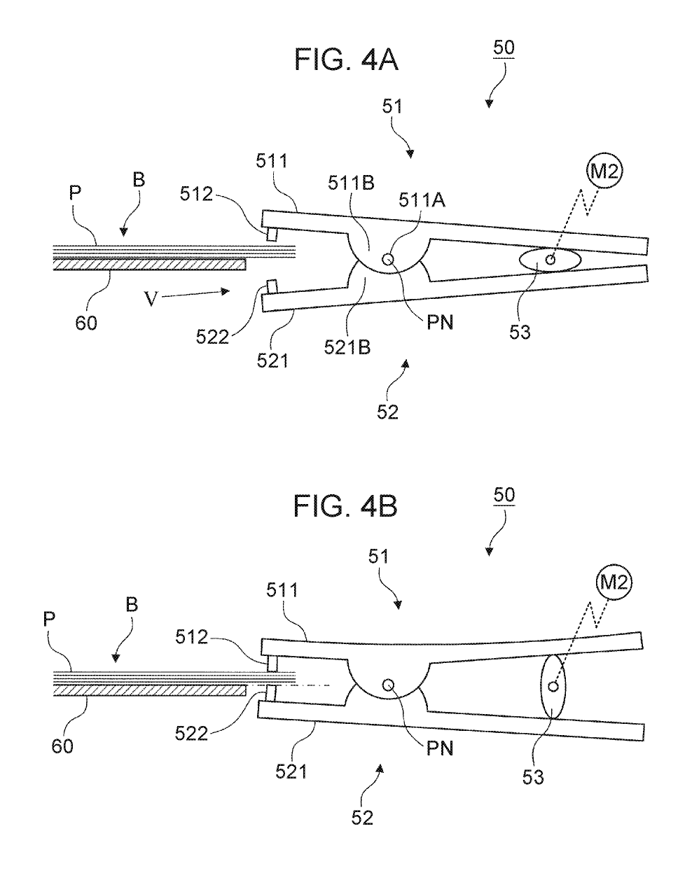

FIGS. 4A and 4B are cross-sectional views taken along line IV-IV in FIG. 3.

As shown in FIG. 4A, the binding unit 50 includes a first driver 51 extending in the left-right direction in FIG. 4A, a second driver 52 similarly extending in the left-right direction in FIG. 4A, an ellipsoidal cam 53 disposed between the first driver 51 and the second driver 52, and a cam motor M2 that drives the cam 53.

The first driver 51 is provided with a driving piece 511. The driving piece 511 is plate-shaped and has a first end at the sheet bundle B side and a second end opposite from the first end.

In this exemplary embodiment, a first advancing member 512 is attached to the first end of the driving piece 511. The first advancing member 512 advances toward the sheet bundle B from one face of the sheet bundle B so as to press against the one face of this sheet bundle B. Furthermore, the driving piece 511 is provided with a protrusion 511B that protrudes toward the second driver 52. The protrusion 511B has a through-hole 511A.

As shown in FIG. 4A, the second driver 52 includes a driving piece 521.

The driving piece 521 is plate-shaped and has a first end at the sheet bundle B side and a second end opposite from the first end. In this exemplary embodiment, a second advancing member 522 is attached to the first end of the driving piece 521. The second advancing member 522 advances toward the other face of the sheet bundle B so as to press against the sheet bundle B.

The driving piece 521 is also provided with a protrusion 521B that protrudes toward the first driver 51. The protrusion 521B has a through-hole (which is not shown but is provided at a position behind the through-hole 511A of the first driver 51).

Furthermore, in this exemplary embodiment, a pin PN extends through the through-hole 511A provided in the first driver 51 and the through-hole (not shown) provided in the second driver 52. In this exemplary embodiment, the driving piece 511 and the driving piece 521 rotate about the pin PN.

Moreover, in this exemplary embodiment, the first advancing member 512 and the second advancing member 522 are provided at the sheet bundle B side relative to the pin PN, and the cam 53 is provided at the side opposite from the side provided with the sheet bundle B with the pin PN interposed therebetween.

As shown in FIG. 4B, when the cam 53 is rotated by the cam motor M2 in this exemplary embodiment, the first advancing member 512 and the second advancing member 522 move toward each other so that the sheet bundle B is nipped by the first advancing member 512 and the second advancing member 522, whereby pressure is applied to the sheet bundle B. This causes the fibers of the sheets P constituting the sheet bundle B to entwine so that adjacent sheets P are joined to each other, whereby a sheet bundle B having undergone a binding process is created.

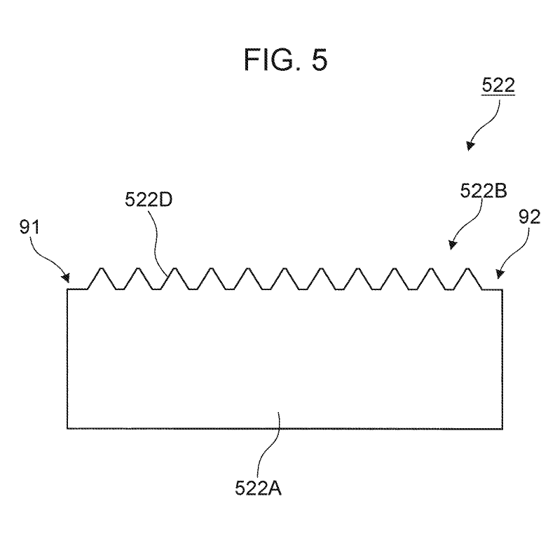

FIG. 5 illustrates the second advancing member 522, as viewed in the direction of an arrow V in FIG. 4A. Although the second advancing member 522 is illustrated as an example in FIG. 5, the first advancing member 512 and the second advancing member 522 have identical configurations except for the fact that they have vertically opposite configurations.

As shown in FIG. 5, the second advancing member 522 has a first end 91 extending in one direction (i.e., the left-right direction) and a second end 92 at the opposite side from the first end 91.

Furthermore, the second advancing member 522 has a rectangular prismatic base 522A. An upper surface 522B of this base 522A is provided with projections and depressions.

More specifically, the upper surface 522B of the base 522A is provided with multiple projections 522D. The projections 522D are arranged in the left-right direction in FIG. 5 (i.e., in the longitudinal direction of the second advancing member 522).

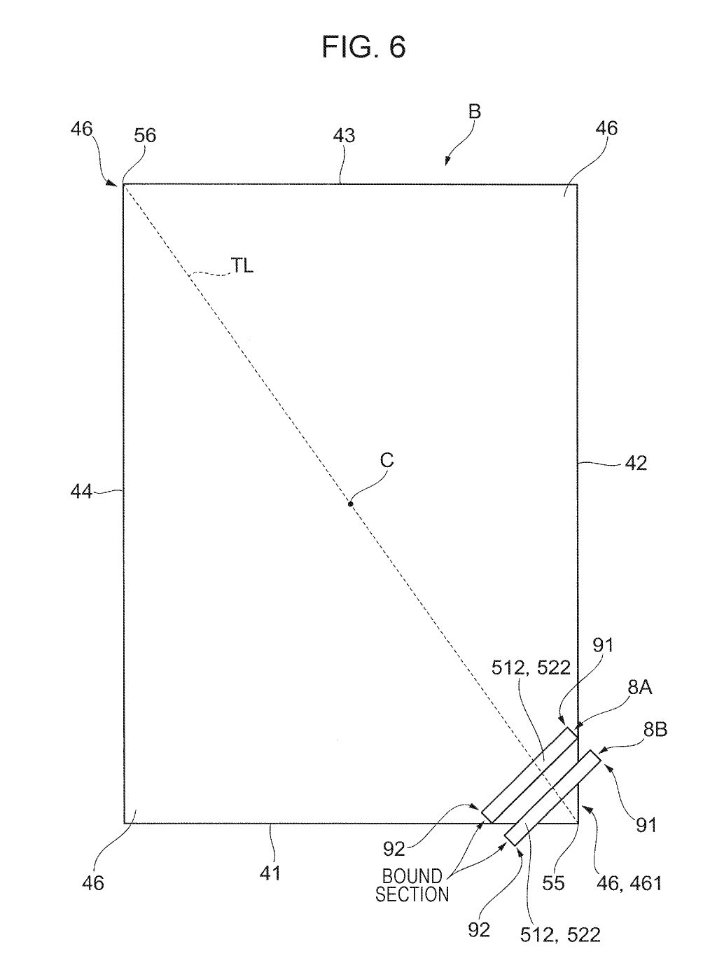

FIG. 6 illustrates a binding process performed on a corner of the sheet bundle B.

This binding process performed on the corner of the sheet bundle B involves causing the first advancing member 512 and the second advancing member 522 to advance toward this corner. Furthermore, in this exemplary embodiment, this corner binding process is performed at the first binding position 8A and the second binding position 8B, which is adjacent to the first binding position 8A.

Moreover, in this exemplary embodiment, the binding process is performed on the sheet bundle B such that a bound section (bound mark) formed as a result of the binding process performed at the first binding position 8A and a bound section (bound mark) formed as a result of the binding process performed at the second binding position 8B are parallel to each other.

The sheet bundle B according to this exemplary embodiment has a rectangular shape when viewed from the front and has first to fourth edges 41 to 44.

Furthermore, the sheet bundle B has four corners 46 at the position where the first edge 41 and the second edge 42 intersect, the position where the second edge 42 and the third edge 43 intersect, the position where the third edge 43 and the fourth edge 44 intersect, and the position where the fourth edge 44 and the first edge 41 intersect, respectively.

In this exemplary embodiment, the binding process is performed on the corner 46 (which will be referred to as “first corner 461” hereinafter) located at the intersection position where the first edge 41 and the second edge 42 intersect (which will be referred to as “first intersection position 55” hereinafter). This binding process for the first corner 461 is performed at the first binding position 8A, which is closer toward a center C of the sheet bundle B, and the second binding position 8B, which is closer to the first intersection position 55 than the first binding position 8A.

Furthermore, in the binding process for the first corner 461, the first advancing member 512 and the second advancing member 522 extend in a direction intersecting a diagonal line of the sheet bundle B (i.e., a diagonal line TL that connects the first intersection position 55 where the first edge 41 and the second edge 42 intersect to an intersection position 56 where the third edge 43 and the fourth edge 44 intersect) and are caused to advance toward the sheet bundle B so as to bind the sheet bundle B together.

Furthermore, in this exemplary embodiment, when the binding process is to be performed at the second binding position 8B (i.e., when the first advancing member 512 and the second advancing member 522 are to press against the sheet bundle B at the second binding position 8B), the first ends 91 and the second ends 92 of the first advancing member 512 and the second advancing member 522 are positioned outside the edges (i.e., the first edge 41 and the second edge 42) of the sheet bundle B.

Thus, in this exemplary embodiment, wrinkles occurring in the sheet bundle B may be reduced, as compared with a case where the first ends 91 and the second ends 92 of the first advancing member 512 and the second advancing member 522 are positioned within the edges of the sheet bundle B.

Furthermore, with the reduced wrinkles in the sheet bundle B, the sheet bundle B may be unlikely to become unbound (i.e., reduction of binding force may be suppressed). If the sheet bundle B is wrinkled, projections and depressions form in the sheet bundle B. Such projections and depressions may cause the sheets to easily become unbound at the bound section. With the first ends 91 and the second ends 92 positioned outside the edges of the sheet bundle B, the projections and depressions are reduced, so that the sheet bundle B may be unlikely to become unbound (i.e., reduction of binding force may be suppressed).

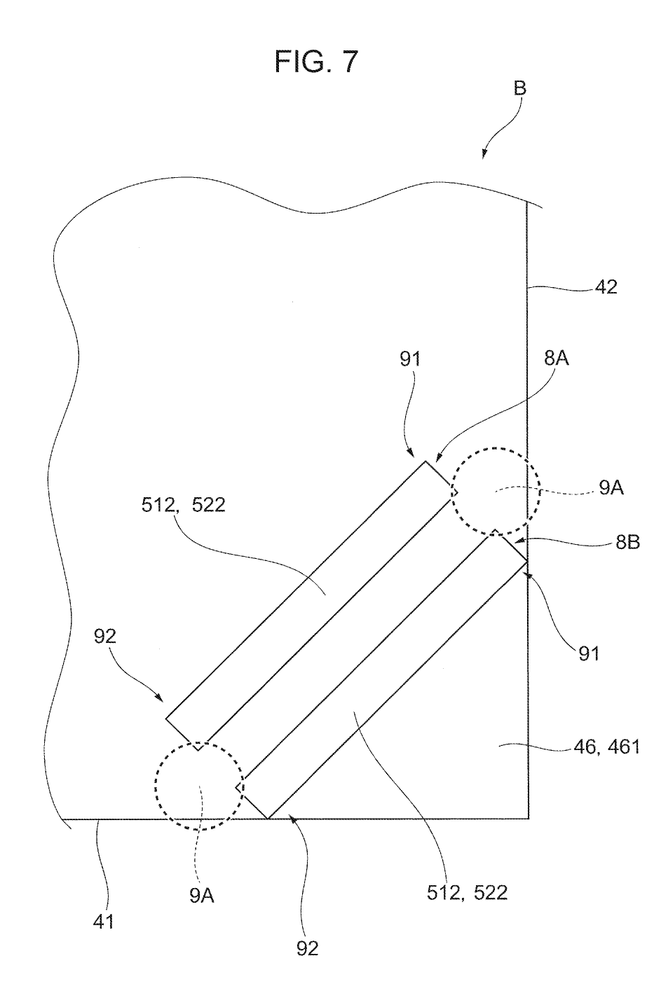

FIG. 7 illustrates a comparative example of a binding process performed on the sheet bundle B.

In this comparative example, when the binding process is to be performed at the second binding position 8B, the first ends 91 and the second ends 92 of the first advancing member 512 and the second advancing member 522 are positioned within the edges (i.e., the first edge 41 and the second edge 42) of the sheet bundle B.

In this case, relatively large wrinkles tend to form in areas 9A, and the binding force is likely to decrease.

If the binding process is to be performed on the sheet bundle B by pressing the first advancing member 512 (and the second advancing member 522) having the first end 91 and the second end 92 against the sheet bundle B, wrinkles tend to form in areas surrounding the first end 91 and the second end 92. In that case, if the binding process is performed such that the two bound sections are adjacent to each other, relatively large wrinkles tend to form in the areas 9A shown in FIG. 7.

In contrast, in this exemplary embodiment, when the binding process is to be performed at one of the binding positions (i.e., when the binding process is to be performed at the second binding position 8B), the first ends 91 and the second ends 92 of the first advancing member 512 and the second advancing member 522 are positioned outside the edges of the sheet bundle B, as described above. In this case, the degree of wrinkling may be reduced so that the sheet bundle B may be unlikely to become unbound, as compared with the comparative example described above.

In this exemplary embodiment, the switching between the binding process at the first binding position 8A (see FIG. 6) and the binding process at the second binding position 8B is performed by moving the sheet bundle B.

In detail, the sheet bundle B is moved by using the first movable members 81 and the second movable member 82 shown in FIG. 3, thereby changing the binding position.

When the binding process is to be performed at the first binding position 8A (see FIG. 6), the binding process is performed on the first corner 461 of the sheet bundle B in the state shown in FIG. 3.

In contrast, when the binding process is to be performed at the second binding position 8B (see FIG. 6), the sheet processing controller 23 outputs a control signal so as to drive the movement motors M1 (see FIG. 3)

Thus, the second movable member 82 moves upward in FIG. 3, and the two first movable members 81 move leftward in FIG. 3. This causes the sheet bundle B to move in the upper left direction in FIG. 3, so that the binding position is changed to the second binding position 8B (not shown in FIG. 3) (see FIG. 6).

In this exemplary embodiment, for example, the sheet processing controller 23, the movement motors M1, and the binding unit 50 function as an advancing unit. With this advancing unit, the binding process at the first binding position 8A and the binding process at the second binding position 8B adjacent to the first binding position 8A are performed.

In other words, with this advancing unit, the first advancing member 512 and the second advancing member 522 are caused to advance toward the sheet bundle B so as to bind the sheet bundle B together. Furthermore, this advancing unit switches between the binding process at the first binding position 8A and the binding process at the second binding position 8B.

In the above description, when performing the binding process at the second binding position 8B, the first ends 91 and the second ends 92 are both positioned outside the edges of the sheet bundle B. Alternatively, only either of the first ends 91 and the second ends 92 may be positioned outside the corresponding edge of the sheet bundle B.

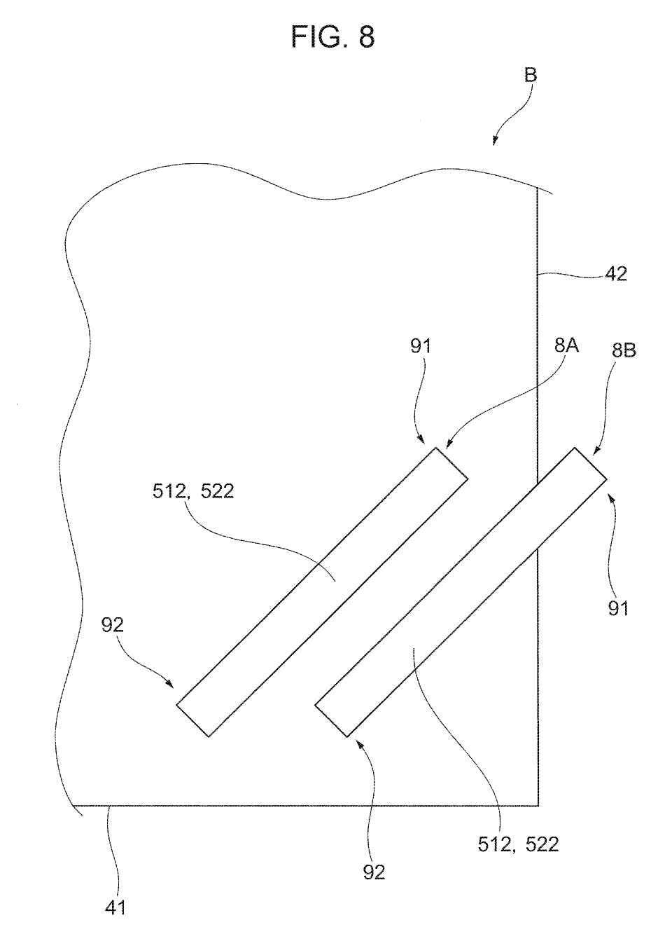

In detail, as shown in FIG. 8 (illustrating another processing example for the sheet bundle B), when performing the binding process at the second binding position 8B, the binding process may be performed in a state where only the first ends 91 of the first advancing member 512 and the second advancing member 522 are positioned outside the corresponding edge (i.e., the second edge 42).

In the processing example shown in FIG. 8, the sheet bundle B is moved leftward after performing a first binding process at the first binding position 8A.

Thus, the sheet bundle B is positioned in a state where it does not face the first ends 91 of the first advancing member 512 and the second advancing member 522. When performing the binding process at the second binding position 8B, the first ends 91 of the first advancing member 512 and the second advancing member 522 are positioned outside the corresponding edge of the sheet bundle B.

Although FIG. 8 corresponds to the case where the first ends 91 of the first advancing member 512 and the second advancing member 522 are positioned outside the corresponding edge of the sheet bundle B, the second ends 92 of the first advancing member 512 and the second advancing member 522 may be positioned outside the corresponding edge of the sheet bundle B.

In this case, the sheet bundle B is moved upward after performing the first binding process at the first binding position 8A. Thus, the second ends 92 of the first advancing member 512 and the second advancing member 522 are positioned outside the corresponding edge of the sheet bundle B.

In the process described above, when performing the binding process at the first binding position 8A, as shown in, for example, FIG. 6, the first ends 91 and the second ends 92 of the first advancing member 512 and the second advancing member 522 are positioned within the edges of the sheet bundle B. However, this is merely one example, and either of or both of the first ends 91 and the second ends 92 may be positioned outside the corresponding edge or edges of the sheet bundle B at the first binding position 8A.

In view of ensuring the binding strength, it is desirable that both of the first ends 91 and the second ends 92 of the first advancing member 512 and the second advancing member 522 be positioned within the corresponding edges of the sheet bundle B when performing the binding process at the first binding position 8A.

In other words, when performing the binding process at multiple binding positions, it is desirable that both of the first ends 91 and the second ends 92 of the first advancing member 512 and the second advancing member 522 be positioned within the corresponding edges of the sheet bundle B in at least one of the binding positions.

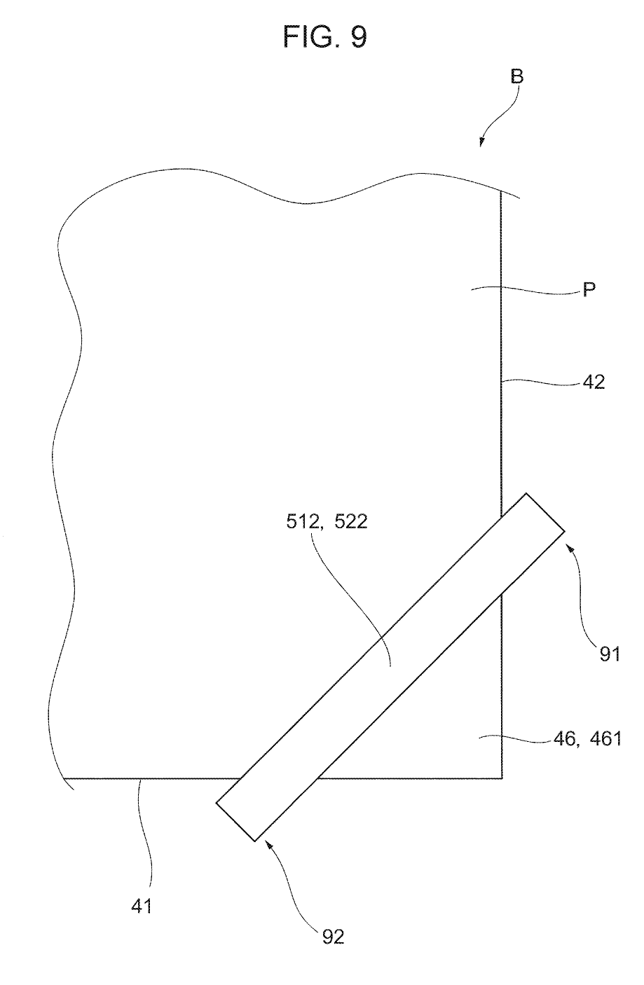

FIG. 9 illustrates another example of the binding process performed on the sheet bundle B.

In this processing example, the binding process is performed at one position, namely, the first corner 461 of the sheet bundle B.

In this processing example, the first ends 91 and the second ends 92 of the first advancing member 512 and the second advancing member 522 are similarly positioned outside the edges (i.e., the first edge 41 and the second edge 42) of the sheet bundle B, so that wrinkles are unlikely to form in the sheets P. Similar to the above description, either of the first ends 91 and the second ends 92 may be positioned outside the sheet bundle B instead of both of them being positioned outside the sheet bundle B.

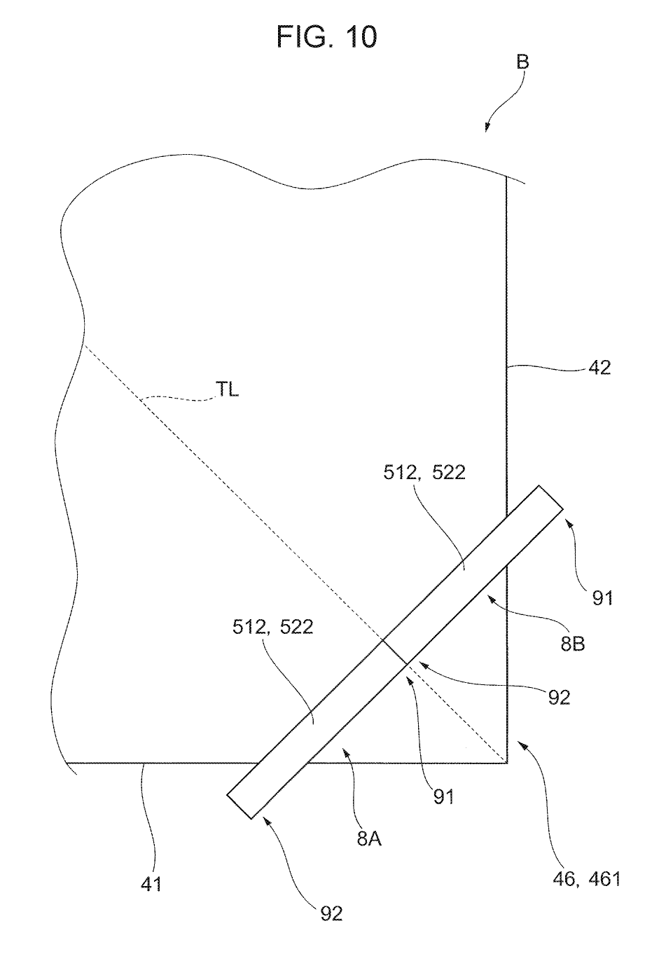

FIG. 10 illustrates another example of the binding process performed on the sheet bundle B.

Similar to the above description, in this processing example, the binding process is performed at two binding positions, namely, the first binding position 8A and the second binding position 8B, but these two binding positions are adjacent to each other in the direction intersecting the diagonal line TL of the sheet bundle B.

In this processing example, when performing the binding process at the first binding position 8A, the second ends 92 of the first advancing member 512 and the second advancing member 522 are positioned outside the corresponding edge (i.e., the first edge 41) of the sheet bundle B. When performing the binding process at the second binding position 8B, the first ends 91 of the first advancing member 512 and the second advancing member 522 are positioned outside the corresponding edge (i.e., the second edge 42) of the sheet bundle B.

### Other Exemplary Embodiments

As described above, the switching between the binding process at the first binding position 8A and the binding process at the second binding position 8B may be performed by moving the sheet bundle B or by moving the binding unit 50. Furthermore, the switching may be performed by moving both of the sheet bundle B and the binding unit 50.

The binding unit 50 may be moved in accordance with a known technique. For example, the binding unit 50 may be moved by using a rack gear that operates in conjunction with the binding unit 50, a pinion gear that engages with the rack gear, and a pinion motor (not shown) that rotates the pinion gear.

Furthermore, in the above description, the binding position is changed by moving the sheet bundle B using the pair of advancing members (i.e., the first advancing member 512 and the second advancing member 522). Alternatively, for example, two pairs of advancing members installed at different positions from each other may be provided, and the binding position may be changed by switching between the pairs of advancing members to be used.

Furthermore, although two advancing members, namely, the first advancing member 512 and the second advancing member 522, are provided in the above description, for example, the second advancing member 522 may be eliminated and be replaced with a support base that supports the sheet bundle B from below.

Furthermore, although the binding process is performed first at the first binding position 8A and the binding process is subsequently performed at the second binding position 8B in the above description, the binding process may be performed first at the second binding position 8B and the binding process may be subsequently performed at the first binding position 8A.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A binding process device comprising:
an advancing member that has a first end and a second end located opposite from the first end and that advances toward a surface of a recording-medium bundle so as to press against the recording-medium bundle;
an advancing unit that causes the advancing member to advance toward the surface of the recording-medium bundle,
wherein when the advancing member advances toward the surface of the recording-medium bundle so as to press against the recording-medium bundle, at least one of the first end and the second end of the advancing member is positioned outside an edge of the recording-medium bundle.

2. The binding process device according to claim 1,
wherein when the advancing member presses against the surface of the recording-medium bundle, both of the first end and the second end of the advancing member are positioned outside the edge of the recording-medium bundle.

3. A binding process device comprising:
an advancing member that has a first end and a second end located opposite from the first end and that advances toward a surface of a recording-medium bundle so as to press against the recording-medium bundle;
an advancing unit that causes the advancing member to advance toward a first position on the surface of the recording-medium bundle and a second position adjacent to the first position,
wherein when the advancing member presses against the recording-medium bundle in at least one of the first position and the second position, at least one of the first end and the second end of the advancing member is positioned outside an edge of the recording-medium bundle.

4. The binding process device according to claim 3,
wherein when the advancing member presses against the recording-medium bundle at the at least one of the first position and the second position, both of the first end and the second end of the advancing member are positioned outside the edge of the recording-medium bundle.

5. The binding process device according to claim 3,
wherein the recording-medium bundle has a corner at an intersection position where two edges intersect,
wherein the advancing unit causes the advancing member to advance toward an area of the corner in the surface of the recording-medium bundle,
wherein the second position is located closer to the intersection position than the first position,
wherein when the advancing member presses against the recording-medium bundle at the first position, the first end and the second end of the advancing member are positioned within the edges of the recording-medium bundle, and
wherein when the advancing member presses against the recording-medium bundle at the second position, at least one of the first end and the second end of the advancing member is positioned outside the edge or edges of the recording-medium bundle.

6. The binding process device according to claim 5,
wherein when the advancing member presses against the recording-medium bundle at the second position, both of the first end and the second end of the advancing member are positioned outside the edges of the recording-medium bundle.

7. A recording-medium processing system comprising:
an image forming apparatus that forms an image onto a recording medium; and
a binding process device that performs a binding process on a plurality of recording media having images formed thereon by the image forming apparatus,
wherein the binding process device is the binding process device according to claim 1.
